(19) United States
(12) Patent Application Publication
(10) Pub. No.: US 2009/0113061 A1
(43) Pub. Date: Apr. 30, 2009

(54) SYSTEM AND METHOD FOR ESTABLISHING COMMUNICATIONS PARAMETERS FOR ELECTRONIC DEVICE

(75) Inventors: Gavan TREDOUX, Penfield, NY (US); Robert Buckley, Rochester, NY (US)

Correspondence Address: Prass LLP, 2661 Riva Road, Building 1000, Suite 1044, Annapolis, MD, 21401, US

(73) Assignee: XEROX CORPORATION, Norwalk, CT (US)

(21) Appl. No.: 11/931,306

(22) Filed: Oct. 31, 2007

(51) Int. Cl. G06F 15/16

(52) U.S. Cl. 709/228

(57) ABSTRACT

Disclosed are methods of establishing communication parameters for communicating between a first electronic device and a second electronic device, and corresponding computer apparatus and computer-readable medium. The embodiments store a device driver indicator on the first electronic device, the device driver indicator for indicating a driver for driving the first electronic device using one of a plurality of different operating systems, determine configuration information for the first electronic device, receive a removable computer-readable medium at the first electronic device, the removable computer-readable medium received from a user of the second electronic device, and transfer the device driver indicator and the configuration information to the removable computer-readable medium. The transferred device driver indicator and the configuration information are installable from the removable computer-readable medium to the second electronic device to establish the communication parameters to allow the second electronic device to communicate with the first electronic device.

### BACKGROUND

Disclosed are methods for establishing communication parameters for an electronic device, and in particular to such methods that establish driver and configuration data for the electronic device, as well as corresponding apparatus and computer-readable medium.

Image forming devices such as printers, copiers and multi-function devices provide users the ability to print, copy and the like from a device such as a desktop or laptop computer, a handheld computer, or other electronic devices to the printer, copier or multifunction device. The electronic devices may be stand alone devices, or may be connected in a network, such as in a business computing environment, which may include one or more printers, for example.

In order for a printer, scanner, multifunction device, and so forth to interface with and function with the electronic device to which it is connected, a device driver can be installed on the electronic device. A device driver, such as a printer driver, is software which controls the printer, scanner or multifunction device from the electronic device. The device driver may include a user interface which may be typically accessed by a user through an operating system or an application program, such as a word processing program, a spreadsheet program, or other types of programs, and viewed on a display on the electronic device. Typically, different versions of the device driver will be created, each for a different one of the many operating systems that may be in use.

When a user wants to connect an electronic device, such as a laptop computer, a handheld computer, a cell phone, a camera, or other electronic device, to a printer, scanner or other multifunction device, the user typically has to go through a cumbersome process of establishing communications parameters by installing a driver for the printer, scanner or other multi-function device, and then determining configuration information, such as the network address, port type and port number of the printer, scanner or other multi-function device, so that it can be properly configured before it is used. The configuration information may be dynamic, such that one or more aspects of the configuration information may change over time.

### SUMMARY

According to aspects of the embodiments, there is provided methods of establishing communications parameters for communication between a first electronic device and a second electronic device, and corresponding computer apparatus and computer-readable medium. The embodiments store a device driver indicator on the first electronic device, the device driver indicator for indicating a driver for driving the first electronic device using one of a plurality of different operating systems, determine configuration information for the first electronic device, receive a removable computer-readable medium at the first electronic device, the removable computer-readable medium received from a user of the second electronic device, and transfer the device driver indicator and the configuration information to the removable computer-readable medium. The transferred device driver indicator and the configuration information are installable from the removable computer-readable medium to the second electronic device to establish the communication parameters to allow the second electronic device to communicate with the first electronic device.

### BRIEF DESCRIPTION OF THE DRAWINGS

FIG. 1 illustrates a block diagram of a system for supplying driver and configuration data for an electronic device;

FIG. 2 illustrates a block diagram of electronic devices and medium used in establishing communication parameters for an electronic device; and

FIG. 3 illustrates a flowchart of a method for establishing communication parameters for communicating between a first electronic device and a second electronic device.

### DETAILED DESCRIPTION

Aspects of the disclosed embodiments relate to methods for supplying communications parameters such as driver and configuration data for an electronic device, and corresponding apparatus and computer readable medium. The disclosed embodiments allow a user to easily transfer communications parameters such as the driver indicators and configuration information from a first electronic device to a second electronic device using the computer-readable medium. The user can then easily load the communications parameters onto the second electronic device, where it may be used to drive the first electronic device, to perform functionality such as printing, scanning, facsimile and the like.

This is particularly useful where the user is unfamiliar with the first electronic device and is trying to establish communication between the first electronic device and the second electronic device for the first time. For example, the user may be connecting a computer to an unfamiliar printer for the first time.

The disclosed embodiments include methods for establishing communication parameters for communicating between a first electronic device and a second electronic device by storing a device driver indicator on the first electronic device, the device driver indicator for indicating a driver for driving the first electronic device using one of a plurality of different operating systems, determining configuration information for the first electronic device, receiving a removable computer-readable medium at the first electronic device, the removable computer-readable medium received from a user of the second electronic device, and transferring the device driver indicator and the configuration information to the removable computer-readable medium. The transferred device driver indicator and the configuration information are installable from the removable computer-readable medium to the second electronic device to establish the communication parameters to allow the second electronic device to communicate with the first electronic device.

The disclosed embodiments further include a computer apparatus that includes a memory that stores a device driver indicator, the device driver indicator for indicating a driver for driving the computer apparatus using one of a plurality of different operating systems, a processor, an interface connected to the processor for receiving a removable computer-readable medium from a user of an electronic device, wherein the processor causes determination of configuration information for the computer apparatus and transfer of the device driver indicator and the configuration information to the first interface for transfer to the removable computer-readable medium, and wherein the transferred device driver indicator and the configuration information are installable from the removable computer-readable medium to the electronic device to establish the communication parameters to allow the electronic device to communicate with the computer apparatus.

The disclosed embodiments further include a computer-readable medium comprising, a computer-usable data carrier storing instructions, the instructions when executed by a computer causing the computer to: store a device driver indicator on a memory of the computer, the device driver indicator for indicating a driver for driving the computer using one of a plurality of different operating systems, determine configuration information of the computer and store the configuration information on the memory of the computer; and transfer the configuration information and the device driver indicator from the computer to a removable computer-readable medium, wherein the transferred device driver indicator and the configuration information are installable from the removable computer-readable medium to the electronic device to establish the communication parameters to allow the electronic device to communicate with the computer.

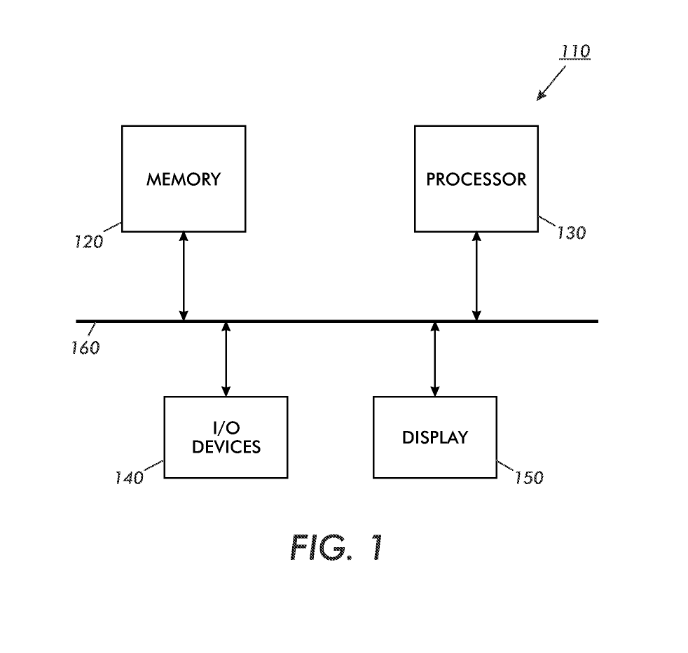

FIG. 1 illustrates a diagram of a system 110. The system 110 may be embodied within devices such as a desktop computer, a laptop computer, a handheld computer, a handheld communication device, or another type of computing or electronic device, or the like. The system 110 may include a memory 120, a processor 130, input/output devices 140, a display 150 and a bus 160. The bus 160 may permit communication and transfer of signals among the components of the computing device 110.

Processor 130 may include at least one conventional processor or microprocessor that interprets and executes instructions. The processor 130 may be a general purpose processor or a special purpose integrated circuit, such as an ASIC, and may include more than one processor section. Additionally, the system 110 may include a plurality of processors 130.

Memory 120 may be a random access memory (RAM) or another type of dynamic storage device that stores information and instructions for execution by processor 130. Memory 120 may also include a read-only memory (ROM) which may include a conventional ROM device or another type of static storage device that stores static information and instructions for processor 130. The memory 120 may be any memory device that stores data for use by system 110.

Input/output devices 140 (I/O devices) may include one or more conventional input mechanisms that permit a user to input information to the system 110, such as a microphone, touchpad, keypad, keyboard, mouse, pen, stylus, voice recognition device, buttons, and the like, and output mechanisms such as one or more conventional mechanisms that output information to the user, including a display, one or more speakers, a storage medium, such as a memory, magnetic or optical disk, disk drive, a printer device, and the like, and/or interfaces for the above. The display 150 may typically be an LCD or CRT display as used on many conventional computing devices, or any other type of display device.

The system 110 may perform functions in response to processor 130 by executing sequences of instructions or instruction sets contained in a computer-readable medium, such as, for example, memory 120. Such instructions may be read into memory 120 from another computer-readable medium, such as a storage device, or from a separate device via a communication interface, or may be downloaded from an external source such as the Internet. The system 110 may be a stand-alone system, such as a personal computer, or may be connected to a network such as an intranet, the Internet, and the like. Other elements may be included with the system 110 as needed.

The memory 120 may store instructions that may be executed by the processor to perform various functions. For example, the memory may store printer driver instructions to allow the system to perform various printing functions in association with a particular printer connected to the system. The printer driver instructions are typically unique to each specific type of printer, and the system 110 may store a plurality of print drivers each for a different printer.

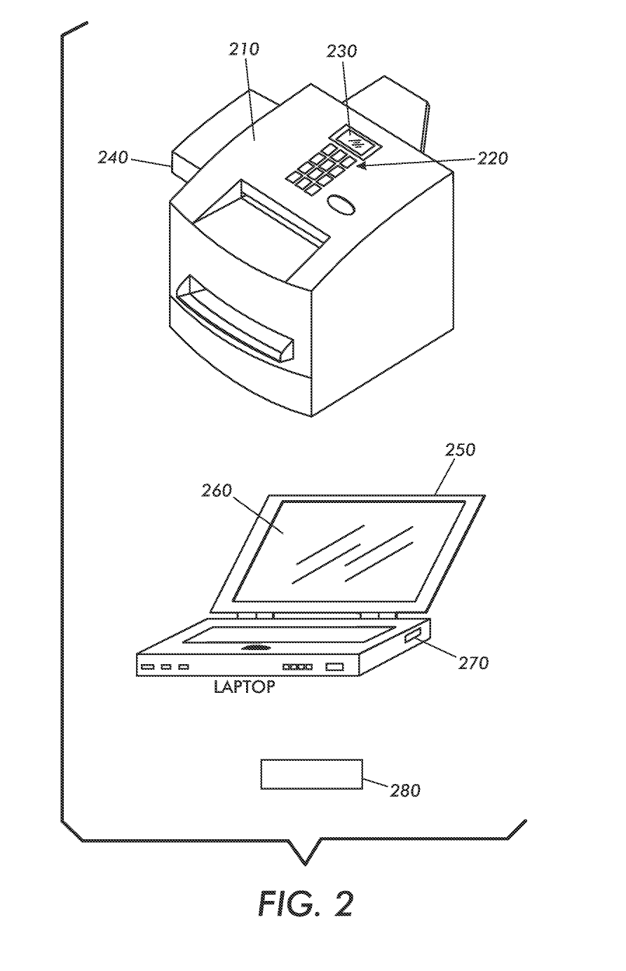

FIG. 2 illustrates various electronic devices that may be used with the embodiments. In particular, FIG. 2 illustrates first electronic device 210 and second electronic device 250. The first electronic device 210 typically may include the elements of system 110, including the memory 120, the processor 130, I/O devices 140 and a display 150.

The first electronic device 210 may include various input/output devices such as a keyboard 220, a display 230, a mouse, connectors for cabling, a wireless interface, and the like. The display 230 may display images to be viewed by a user.

The first electronic device 210 may also include other input or output interfaces, such as a USB (universal serial bus) port 240, and the like. A USB port allows peripherals, such as USB flash drive 280, or other removable computer-readable medium, to be connected to, and interface with the USB port 240 and with a processor, memory and other elements within the first electronic device 210. Information may be downloaded from the first electronic device and stored on the USB flash drive 280, such as executable programs, drivers, driver indicators, configuration data, and the like. Other types of computer-readable medium may be used in place of the flash drive 280, such as CD or miniCD, DVD or miniDVD, floppy disk, memory stick, mini or microSD, and the like. Some of these computer-readable medium require an interface other than a USB port, such as a DVD and/or CD reader, a miniSD memory card slot, and the like. The appropriate type of computer-readable medium may be used dependent on the interfaces available on the first electronic device 210.

The second electronic device 250 could be a laptop computer as illustrated in FIG. 2, or could be another type of electronic device such as a handheld computer, a cell phone, a PDA (personal data assistant), a camera, a desktop computer, an MP3 player, and the like. The second electronic device 250 may also include various input/output devices such as a keyboard, a display 260, a mouse (not shown), connectors for cabling, a wireless interface, USB port 270, and the like. The display 260 may display images to be viewed by a user.

Disclosed embodiments allow a user wanting to establish communication between the first electronic device 210 and the second electronic device 250, to easily load the needed data from the first electronic device 210, onto the USB flash drive 280, and then onto the second electronic device 250, even when the user is unfamiliar with the first electronic device 210, or what information is needed to be loaded. For example, where the first electronic device 210 is a printer, scanner or multifunction device that a user of the second electronic device 250 is unfamiliar with but wants to drive, for example to print a document from the second electronic device 250, typically the user will have to load a driver for the first electronic device 210 onto the second electronic device 250, as well as configuration information to establish the needed communication parameters. This requires specialized knowledge which can be hard to acquire, especially when the user is unfamiliar with the first electronic device 210.

For example, the user may be away from his home or office and may be trying to connect his device to an unfamiliar or unknown electronic device for which he has no driver, and may not know or be able to obtain the needed configuration information. The configuration information may include data such as the network address, port type, port number or service name, or other configuration data.

Embodiments allow a user of the second electronic device 250 to easily obtain and load the needed communication parameters such as the device driver and configuration information into the memory of the second electronic device 250, where it may be used to drive the first electronic device 210. Embodiments cause the first electronic device to determine the needed configuration information. The configuration information may be information that changes as may be caused by current or future protocols, so it is determined by the first electronic device 210 when needed by the second electronic device 250.

A device driver, such as a printer driver, is software which controls the printer, scanner or multifunction device from the electronic device. Device drivers for the first electronic device 210 may be stored in the memory of the first electronic device 210, or may be stored in the memory of the second electronic device 250. Different device drivers corresponding to various operating systems in use are stored. Additionally, any needed configuration information is determined, which may include data such as the network address, port type, port number or service name, or other configuration data. The configuration information may include a network protocol, such as a Raw protocol, an LPR protocol, an IPP protocol, or a WSD protocol.

Where the drivers are stored in the memory of the second electronic device, a device driver indicator may be provided and stored in the memory of the first electronic device, which simply indicates the needed driver. The user of the first electronic device 210 may load the needed driver indicator and configuration information onto the USB flash drive 280 by connecting the USB flash drive 280 to the USB port 240. The user may indicate to the first electronic device 210 the type of operating system that is used by the second electronic device 250, and the first electronic device 210 may select (or generate) and store a driver indicator that corresponds to the indicated operating system, and load it onto the USB flash drive 280 through the USB port 240.

Where the device driver is not loaded into the memory of the second electronic device to be selected by the device driver indicator, the device driver indicator may actually include the corresponding device driver itself. Alternatively, a plurality or all of the device drivers could be loaded along with the configuration information onto the USB flash drive 280, so that the user will not need to know or indicate the type of operating system.

The device driver indicator and configuration information may be packaged in one or more executable installer program by well-know procedures. The user may be prompted by the first electronic device to indicate the type of operating system the user's device has installed, such as through a prompt on display 230. Further, the user may indicate the type of operating system through an input device, such as input into keyboard 220. Other means could be used to indicate the type of operating system, such as wireless transmission between the first and second electronic devices 210, 250.

After the driver indicator and configuration data are loaded onto the USB flash drive 280, the USB flash drive 280 is connected to the second electronic device 250 at the USB port 270, for example. The driver indicator and configuration information may then be loaded onto the first electronic device 210 by use of the executable installer program, for example. The driver indicator and configuration information establish the communication parameters for communicating between the first electronic device 210 and the second electronic device 250. The user may then drive the second electronic device 250 from the first electronic device 210, to perform desired functionality, such as printing, scanning, faxing, and the like. Data may be transferred between the first and second electronic devices by connection of a cable, (not shown), through a wireless connection, by connection through a network such as a business network, an intranet, a LAN, a WAN, the Internet, and the like.

Embodiments as disclosed herein may also include computer-readable medium for carrying or having computer-executable instructions or data structures stored thereon. Such computer-readable medium can be any available medium that can be accessed by a general purpose or special purpose computer. By way of example, and not limitation, such computer-readable medium can comprise RAM, ROM, EEPROM, CD-ROM or other optical disk storage, magnetic disk storage or other magnetic storage devices, or any other medium which can be used to carry or store desired program code means in the form of computer-executable instructions or data structures. When information is transferred or provided over a network or another communications connection (either hardwired, wireless, or combination thereof) to a computer, the computer properly views the connection as a computer-readable medium. Thus, any such connection is properly termed a computer-readable medium. Combinations of the above should also be included within the scope of the computer-readable medium.

Computer-executable instructions include, for example, instructions and data which cause a general purpose computer, special purpose computer, or special purpose processing device to perform a certain function or group of functions. Computer-executable instructions also include program modules that are executed by computers in stand-alone or network environments. Generally, program modules include routines, programs, objects, components, and data structures, and the like that perform particular tasks or implement particular abstract data types. Computer-executable instructions, associated data structures, and program modules represent examples of the program code means for executing steps of the methods disclosed herein. The particular sequence of such executable instructions or associated data structures represents examples of corresponding acts for implementing the functions described therein. The instructions for carrying out the functionality of the disclosed embodiments may be stored on such a computer-readable medium.

The instructions from a computer-readable medium may be used by an electronic device, such as first electronic device 210, to cause the functionality of the embodiments to occur. These instructions may be loaded into a memory of the first electronic device 210 to be executed by a processor as needed.

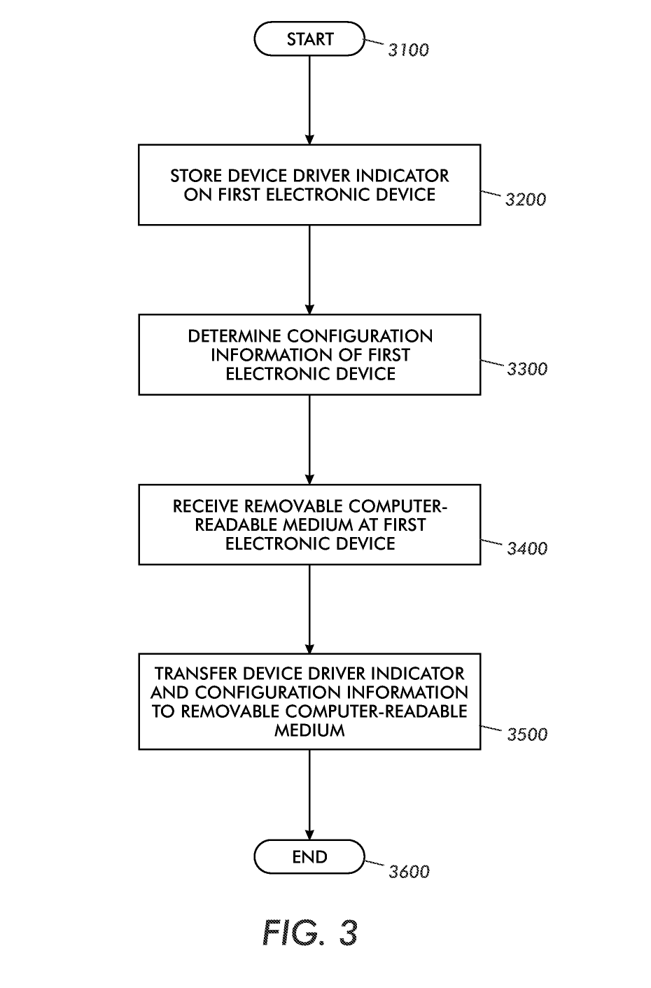

FIG. 3 illustrates a flowchart of a method for establishing communication parameters for an electronic device. The method starts at 3100. At 3200, a device driver indicator is stored in the memory of the first electronic device 210, the device driver indicator corresponding to an operating system of the second electronic device. At 3300, configuration information for the first electronic device 210 is determined. This configuration information may be determined by procedures known as “device discovery.”

At 3400, a removable computer-readable medium is received at the first electronic device 210. At 3500, the device driver indicator and the configuration information are transferred to the removable computer-readable media. The transferred device driver indicator and the configuration information are installable from the removable computer-readable medium to the second electronic device 250 to establish communications parameters to allow the second electronic device 250 to drive the first electronic device 210. At 3600, the method ends.

It will be appreciated that various of the above-disclosed and other features and functions, or alternatives thereof, may be desirably combined into many other different systems or applications. Also that various presently unforeseen or unanticipated alternatives, modifications, variations or improvements therein may be subsequently made by those skilled in the art which are also intended to be encompassed by the following claims.

What is claimed is:

1. A method of establishing communication parameters for communicating between a first electronic device and a second electronic device, comprising:
storing a device driver indicator on the first electronic device, the device driver indicator for indicating a driver to drive the first electronic device using one of a plurality of different operating systems;
determining configuration information for the first electronic device;
receiving a removable computer-readable medium at the first electronic device, the removable computer-readable medium received from a user of the second electronic device; and
transferring the device driver indicator and the configuration information to the removable computer-readable medium,
wherein the transferred device driver indicator and the configuration information are installable from the removable computer-readable medium to the second electronic device to establish the communication parameters to allow the second electronic device to communicate with the first electronic device.

2. The method of claim 1, wherein the configuration information includes a network address of the first electronic device, a port type of the first electronic device, and a port number or service name of the first electronic device.

3. The method of claim 1, wherein the configuration information includes a network protocol.

4. The method of claim 3, wherein the network protocol is one of a Raw protocol, an LPR protocol, an IPP protocol, or a WSD protocol.

5. The method of claim 1, wherein transferring the device driver indicator and the configuration information to the removable computer-readable medium further comprises packaging the device driver indicator and the configuration information in an executable installer program.

6. The method of claim 1, wherein transferring the device driver indicator and the configuration information to the removable computer-readable medium comprises transferring a plurality of device drivers each corresponding to a different operating system that may be used by the second electronic device and the configuration information to the removable computer-readable medium in at least one executable installer program.

7. The method of claim 1, wherein the first electronic device is one of a printer, a scanner, a facsimile device or a multi-function device.

8. The method of claim 1, wherein the second electronic device is one of a laptop computer, a cellular phone, a camera, a desktop computer, or a PDA.

9. A computer apparatus, comprising:
a memory that stores a device driver indicator for the computer apparatus, the device driver indicator for indicating a driver for driving the computer apparatus using one of a plurality of different operating systems;
a processor;
an interface connected to the processor for receiving a removable computer-readable medium from a user of an electronic device; and
wherein the processor causes determination of configuration information for the computer apparatus and transfer of the device driver indicator and the configuration information to the first interface for transfer to the removable computer-readable medium, and wherein the transferred device driver indicator and the configuration information are installable from the removable computer-readable medium to the electronic device to establish the communication parameters to allow the electronic device to communicate with the computer apparatus.

10. The computer apparatus of claim 9, wherein the configuration information includes a network address of the computer apparatus, a port type of the computer apparatus, and a port number or service name of the computer apparatus.

11. The computer apparatus of claim 9, wherein the configuration information includes a network protocol.

12. The computer apparatus of claim 11, wherein the network protocol is one of a Raw protocol, an LPR protocol, an IPP protocol, or a WSD protocol.

13. The computer apparatus of claim 9, wherein the processor packages the device driver indicator and the configuration information in an executable installer program, and causes transfer of the executable installer program to the removable computer-readable medium.

14. The computer apparatus of claim 9, wherein the device driver indicator comprises a plurality of device drivers, and the processor packages the plurality of device drivers and the configuration information in at least one executable installer program, and causes transfer of the at least one executable installer program to the removable computer-readable medium.

15. The computer apparatus of claim 9, wherein the computer apparatus is one of a printer, a scanner, a facsimile device or a multi-function device.

16. A computer-readable medium comprising:
a computer-usable data carrier storing instructions, the instructions when executed by a computer causing the computer to:
store a device driver indicator on a memory of the computer, the device driver indicator for indicating a driver for driving the computer using one of a plurality of different operating systems;
determine configuration information of the computer and store the configuration information on the memory of the computer; and
transfer the configuration information and the device driver indicator from the computer to a removable computer-readable medium,
wherein the transferred device driver indicator and the configuration information are installable from the removable computer-readable medium to the electronic device to establish communication parameters to allow the electronic device to communicate with the computer.

17. The computer-readable medium of claim 16, wherein the configuration information includes a network address of the computer, a port type of the computer, and a port number or service name of the computer.

18. The computer-readable medium of claim 16, wherein the configuration information includes a network protocol.

19. The computer-readable medium of claim 16, wherein the instructions further cause the computer to package the device driver indicator and the configuration information in an executable installer program.

20. The computer-readable medium of claim 16, wherein the computer is one of a printer, a scanner, a facsimile device or a multi-function device and the electronic device is one of a laptop computer, a cellular phone, a camera, a desktop computer, or a PDA.
